(19) United States
(12) Patent Application Publication
(10) Pub. No.: US 2017/0366545 A1
(43) Pub. Date: Dec. 21, 2017

(54) SEALED NETWORK EXTERNAL APPLICATIONS

(71) Applicant: Lior Malka, San Jose, CA (US)

(72) Inventor: Lior Malka, San Jose, CA (US)

(21) Appl. No.: 15/186,459

(22) Filed: Jun. 18, 2016

(51) Int. Cl. H04L 29/06; G06F 21/62; G06F 21/60; G06Q 10/08; G06Q 20/10

(52) U.S. Cl. CPC H04L 63/10; G06Q 10/083; G06Q 20/10; G06F 21/602; G06F 21/6218; G06Q 2220/00

(57) ABSTRACT

Embodiments are provided for external applications in a sealed network. A sealed network does not require administrators and may run on hardware and software that has been stripped of privileged capabilities. External applications connect to the sealed network from devices outside of the network. In one embodiment, an obfuscator generates an external application associated with a user. In one embodiment, an indirect external application provides an application programming interface. In one embodiment, an external party delegates a function to a sealed network.

### BACKGROUND

Existing networks require an administrator. An administrator has privileged capabilities for managing remote devices, such as remote access, software installation, user and passwords modifications, and so on. Networks that require administrators are more expensive and less secure than sealed networks. A sealed network does not require an administrator. However, because a network is sealed, methods are needed so that external applications can communicate with the sealed network.

### SUMMARY

Embodiments are provided for external applications in a sealed network. A sealed network does not require administrators and may run on hardware and software that has been stripped of privileged capabilities. External applications run on devices external to the sealed network, and allow users or any logic to securely connect to the sealed network. An external application is direct if it provides a user interface. An indirect external application may provide an application programming interface. In one embodiment, an external application is added to the sealed network by providing input including a user identifier to a server, and generating a new external application instance associated with the user identifier. Any obfuscation can be used to generate the instance. In one embodiment, an indirect external application connects to a sealed network and provides an application programming interface that can be enabled or disabled. In one embodiment, an external party delegates a function to a sealed network.

### DRAWINGS

The following figures illustrate the embodiments by way of example. They do not limit their scope.

FIG. 1 shows a flow diagram of a method of adding an external application to a sealed network, in accordance with one embodiment.

FIG. 2 shows a flow diagram of a method of an indirect external application, in accordance with one embodiment.

FIG. 3 shows a flow diagram of a method of delegating a function to a sealed network, in accordance with one embodiment.

### DETAILED DESCRIPTION

This section includes detailed examples, particular embodiments, and specific terminology. These are not meant to limit the scope. They are intended to provide clear and through understanding, cover alternatives, modifications, and equivalents.

A network is a collection of devices. Each device has zero or more parties executing on it. Each party has a unique identifier. A Party may be multithreaded, and each thread may be communicating with other parties using an address. The parties that communicate with a party are the neighbors of that party. Communication channels may be secure or not or both.

A sealed network is a network that does not require administrators. It is guided by an operator using a control panel. A party that provides a control panel is called a root. A party for general purpose applications is a server. A party that controls servers is a node. A device may have any number of roots, nodes, and servers. All parties may be obfuscated. The obfuscated code is called an instance. An instance is generated by providing randomness and instance inputs to an obfuscator, and compiling the obfuscator output. All instances may have files or databases that are protected, fully or partially, with cryptographic functions, such as encryption, signatures, and signcryption. The description of those functions and their keys may also be protected using a cryptographic function that is obfuscated in the instance.

A party that communicates with a sealed network, but executes outside of the sealed network, is called an external application. Every external application is associated with a user identifier. A sealed network may generate instances of external applications. An external application is direct if it has a user interface. The interface may or may not be graphic. Every user has at least one direct external application. An indirect external application may provide an application programming interface (API), which is a collection of functions. A function may take an input and may return an output. Any method for providing access to the functions and their return values may be used. For example, pointers, drivers, system calls, signals, sockets, files, and so on.

Delegation involves a sealed network user, a function, and a party external to the sealed network. The user provides an identifier to the external party, who forwards the identifier to the sealed network. The sealed network computes the function on user data and provides the function output to the external party. Any identifier may be used. For example, the user may choose an email address or a one-time token issued by the sealed network as an identifier. Any function may be used. For example, the function may return TRUE if and only if the user is authentic. Or it may return a shipping address, or a payment confirmation, or both.

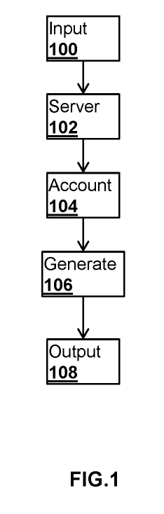

FIG. 1 shows a flow diagram of adding an external application to a sealed network, in accordance with one embodiment. The application may be direct or indirect. The input 100 includes a user identifier. The input may be received in any way. For example, the network may issue a unique user identifier if the user is new, and otherwise the network may use the identifier of the requesting user.

A server 102 in the sealed network receives the input. The server issues a unique instance identifier and associates it with the user identifier. The server also issues an account for secure communication between the server and the instance. Using the instance identifier, the account, and the server address, the server generates 106 a new instance, and provides it as output 108. Any obfuscator may be used to generate the instance. The server may offload the generation by forwarding the instance identifier, the account, and the server address to another server.

The instance, when launched, securely connects to the server using the address and the account.

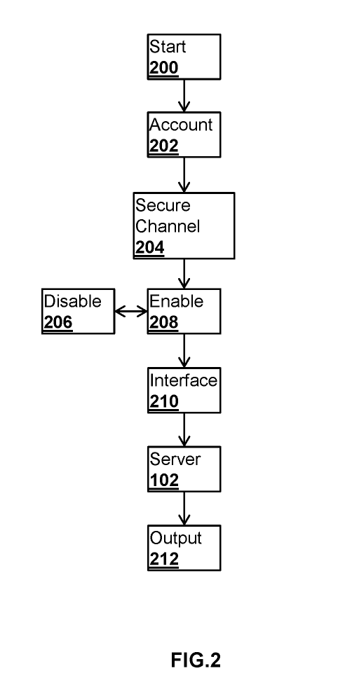

FIG. 2 shows a flow diagram of a method of an indirect external application, in accordance with one embodiment. After the external application is started 200, it reads an account 202 for secure communication. The account is associated with an address. The account may be read from a file or from a database. More than one account may be present. The external application uses one of accounts and the address associated with the account to establish a secure channel 204 with a login server in the sealed network. Any method of establishing a secure channel may be used.

The login server may switch the external application between an enabled and a disabled mode at any time. For example, it may always initialize the external application to an enabled or a disabled mode. The login server may also switch the mode based on configurations set by the user associated with the external application. The application receives services via the login server if and only if it is in enabled mode.

In enabled mode, the application provides an application programming interface 210. When a caller makes a function call on the interface, the external application sends the details of the call to a server 102 in the sealed network. The server processes the call, and sends back the return value as output 212. The external application provides the output to the caller. The server may or may not be the login server.

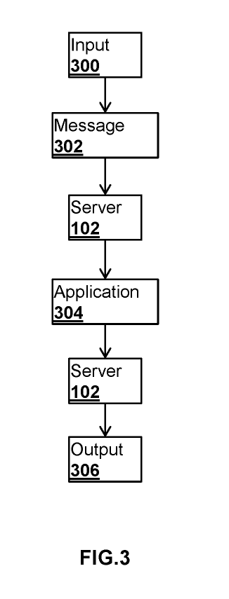

FIG.3 shows a flow diagram of a method of delegating a function to a sealed network. A user provides input 300 to an external party. The input includes an identifier. The external party sends a message 302 to the sealed network over a secure channel. The message contains the identifier. It may also include other data from the input, and parameters from the external party. A server 102 in the sealed network receives the message. The server validates the message, and sends a notification based on the message to a direct external application 304 associated with the user. If the server receives an approval from the direct external application and the approval is received within a time bounded by a threshold, then the server computes the output of the function, and sends the output 306 to the external party.

In a first example, the identifier may be a first email address, the external party may be a website, the message may include only the identifier, the server may send a notification indicating the identity of the website and asking whether the user would like to authenticate to the website, the user may approve, the server would check that the first email equals a second email associated with the user in the sealed network, and send TRUE to the external party if and only if the first email and the second email are equal.

In a second example, the identifier may be a random token issued to the user by the network, the external party may be a website, the message may include only the identifier, the server may send a notification indicating the identity of the website, the direct external application of the user would send an approval to the server, and the server would forward the shipping address of the user to the website. The server may also forward payment information, or it may wait to receive payment information from the external party and execute the payment on behalf of the user.

What is claimed is:

1. A method of adding an external application to a sealed network, the method comprising:
providing input including a user identifier to a server; and
issuing a unique instance identifier, associating it with the user identifier; and
creating an account for secure communication between the instance and the server; and
generating an external application instance using the instance identifier, the account, and the server address; and
outputting the instance.

2. The Method of claim 1, wherein generating an external application instance using the instance identifier, the account, and the server address uses an obfuscator that protects files of the instance using a cryptographic function that is obfuscated in the instance.

3. The Method of claim 1, wherein the user identifier is a unique identifier issued by the network to a new user whose username and a password that are associated with the user identifier.

4. The Method of claim 1, wherein the user identifier is associated with an existing user.

5. The Method of claim 1, further comprising verifying the identity of the user associated with the user identifier.

6. A method of an indirect external application, the method comprising:
establishing a secure channel with a server using an account; and
switching between an enabled and a disabled mode; and
providing an application programming interface; and
relaying calls on the interface to the server and returning the result as output.

7. The method of claim 6, wherein the account is selected from a plurality of accounts based on a least used policy.

8. The method of claim 6, wherein establishing a secure channel with a server using an account is retried if failed, using another account if a plurality of accounts is available.

9. The method of claim 6, wherein switching between an enabled and a disabled mode is controlled by the user associated with the indirect external application.

10. The method of claim 6, wherein switching between an enabled and a disabled mode is controlled by the server and the disabled mode is selected if abnormal behavior occurs.

11. A method of delegating a function to a sealed network, the method comprising:
providing an identifier by a user to an external party; and
sending a message containing the identifier from the external party to a server; and
notifying a direct external application associated by the identifier with the user; and
computing the function if a confirmation is received;
and sending the output of the function to the external party.

12. The Method of claim 11, wherein the external party uses an indirect external application to communicate securely with the server.

13. The Method of claim 11, wherein the identifier is an email address.

14. The Method of claim 11, wherein the identifier is a random token selected by the network and provided to the user.

15. The Method of claim 11, wherein a confirmation is automated.

16. The Method of claim 11, wherein the function returns TRUE if and only if a confirmation is received.

17. The Method of claim 11, wherein the function returns the shipping address and the payment method of the user if and only if a confirmation is received, and payment is executed by the network on behalf of the user.
